(19) United States
(12) Patent Application Publication
(10) Pub. No.: US 2011/0024283 A1
(43) Pub. Date: Feb. 3, 2011

(54) Ammonia Production And Water Purification

(76) Inventor: Bruce H. Peters, Colorado Springs, CO (US)

Correspondence Address: Pannell Law, LLC, 13540 Northgate Estates Drive, Suite 200, Colorado Springs, CO, 80921, US

(21) Appl. No.: 12/903,639

(22) Filed: Oct. 13, 2010

Related U.S. Application Data
(63) Continuation-in-part of application No. 12/277,134, filed on Nov. 24, 2008.
(60) Provisional application No. 61/382,856, filed on Sep. 14, 2010.

(51) Int. Cl. B01D 3/34

(52) U.S. Cl. 203/53; 202/163

(57) ABSTRACT

A method for purifying water and generating ammonia liquor is disclosed. Hydrogen, oxygen, organic matter contaminated water vapor, and ambient air, containing nitrogen, are provided to a combustion chamber. The hydrogen is combusted in the oxygen in the combustion chamber with the contaminated water vapor and nitrogen. The nitrogen is fixated. Water vapor is produced. The contaminated water vapor is heated to decontaminate the contaminated water vapor. The produced water vapor, fixated nitrogen, and organic matter decontaminated water vapor are exhausted from the combustion chamber. The generated water vapor, fixated nitrogen, and decontaminated water vapor are condensed to obtain ammonia liquor. Water is evaporated from the ammonia liquor to form purified water vapor and concentrate the ammonia liquor.

### RELATED APPLICATIONS

This application is a Continuation in Part of co-pending U.S. application Ser. No. 12/277,134, filed Nov. 24, 2008. This application claims the benefit of U.S. Provisional Application No. 61/382,856 filed Sep. 14, 2010.

### BACKGROUND

A vast number of people throughout the world lack access to a healthy drinking water supply. Many of those people live near water sources, but the water from those sources is unfit for drinking and the people have no ready means of purifying the water.

### DESCRIPTION OF THE DRAWINGS

FIG. 1 is an illustration of an embodiment of the present invention system for purifying water.

FIG. 2 is a flow chart illustrating one embodiment of the present invention method for purifying water.

FIG. 3 is an illustration of an embodiment of the present invention for production of water and ammonia by passing water vapor through a hydrogen-powered burn chamber and separating potable water from nitrates and ammonia by evaporation.

FIG. 4 is a flow chart illustrating one embodiment of the present invention method for production of water and ammonia by passing water vapor through a hydrogen-powered burn chamber and separating potable water from nitrates and ammonia by evaporation.

### DETAILED DESCRIPTION

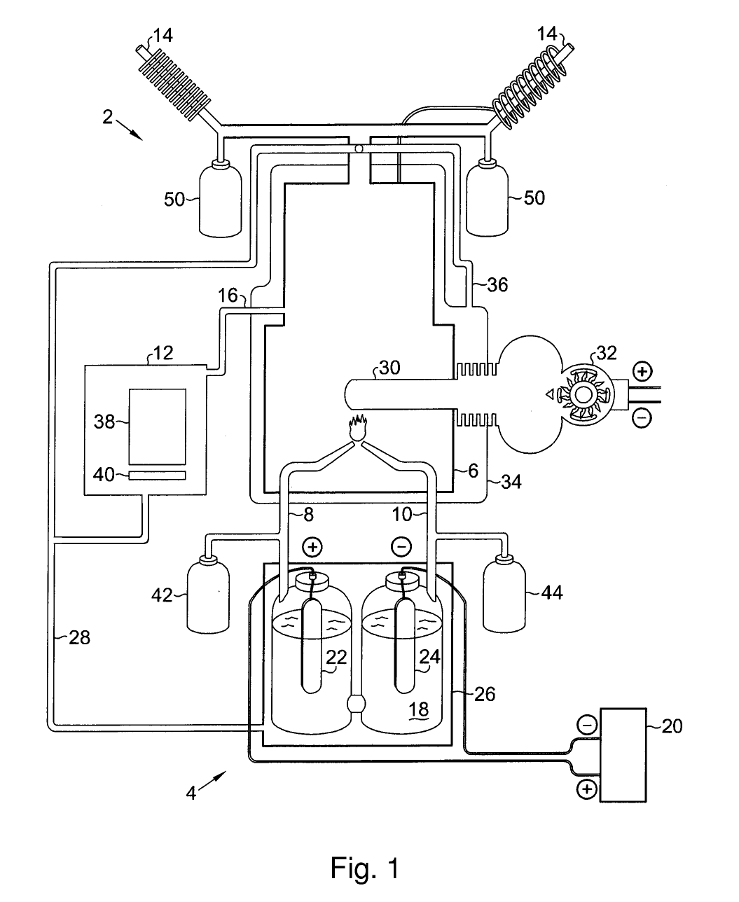

FIG. 1 illustrates an embodiment of the present invention system 2 for water purification. Water purification system 2 includes water electrolysis system 4, combustion chamber, or burn chamber, 6, oxygen channel 8, hydrogen channel 10, water vapor production chamber 12, condensation chamber 14, and water vapor conduit 16.

Water electrolysis system 4 generates hydrogen and oxygen from water. In one embodiment, water electrolysis system 4 includes electrolytic chamber 18 and direct current voltage source 20. Direct current voltage source is any source of direct current, either originating as direct current or rectified to direct current from alternating current, such as solar, wind, or nuclear power, power generated from an external combustion engine 30, or any other direct current voltage source.

Direct current voltage source 20 has anode 22 and cathode 24. Both anode 22 and cathode 24 are disposed in electrolytic chamber 18. Water 26 in electrolytic chamber 18 is decomposed into oxygen and hydrogen at anode 22 and cathode 24, respectively.

In addition to hydrogen and oxygen, the water electrolysis process also generates heat. In one embodiment, system 2 further includes means for capturing heated air from the water electrolysis process and means for introducing the captured heated air into combustion chamber 6 to augment the vacuum generated by the heated water vapor traveling from combustion chamber 6 to condensation chamber 14. The heated air may also be introduced into or bubbled into water below water vapor production chamber 12 to augment evaporation of the water source.

Examples of the means for capturing the heated air include a jacket or casing 26 surrounding electrolytic chamber 18. The heated air is generated between electrolytic chamber 18 and jacket 26 and introduced into combustion chamber 6 through heated air channel 28 between jacket 26 and combustion chamber 6.

Hydrogen channel 10 is disposed to transport hydrogen from water electrolysis system 4 to combustion chamber 6. Oxygen channel 8 is disposed to transport oxygen from water electrolysis system 4 to combustion chamber 6. In one embodiment, all of the hydrogen and oxygen generated from the water electrolysis process is transported to combustion chamber 6.

In an alternative embodiment, some of the oxygen and hydrogen generated from the water electrolysis process is stored for future use or for other uses. Hydrogen storage system 44 is in fluid communication with hydrogen channel 10 and oxygen storage system 42 is in fluid communication with oxygen channel 8 so that some of the hydrogen and oxygen may be stored.

Combustion chamber 6 is a chamber for combusting hydrogen from electrolysis system 4 in oxygen from electrolysis system 4 to generate heated water vapor. In addition to water vapor, the combustion process also generates heat. In one embodiment combustion chamber 6 is tightly insulated to ensure that as much of the heat generated by the combustion process as possible is contained within combustion chamber 6 and flows with heated water vapor into condensation chamber 14.

In one embodiment, system 2 further includes means for capturing air external to combustion chamber 6, heated from the combustion process within combustion chamber 6 and means for introducing the captured heated air into combustion chamber 6 to augment the vacuum generated by the heated water vapor traveling from combustion chamber 6 to condensation chamber 14. This heated air may also be introduced into or bubbled into water below water vapor production chamber 12 to augment evaporation of the water source.

Examples of the means for capturing the heated air include a jacket or casing 34 surrounding combustion chamber 6. The heated air is generated between combustion chamber 6 and jacket 34 and introduced into combustion chamber 6 through heated air channel 36 between jacket 34 and combustion chamber 6.

In one embodiment, system 2 further includes external combustion engine 30 and electrical power generation system 32. One example of an external combustion engine is a Stirling engine. Another example of an external combustion engine is a steam engine. External combustion engine 30 is disposed to utilize the combustion of hydrogen within combustion chamber 6 as a source of external combustion. Electrical power generation system 32 is powered by external combustion engine 30 and, in one embodiment, provides electrical power to direct current voltage source 20.

Water vapor production chamber 12 generates water vapor from water. In one embodiment, water vapor production chamber 12 is a chamber for boiling water to produce water vapor and includes a water container 38 and a heat source 40 disposed adjacent water container 38. In an alternate embodiment, water vapor production chamber 12 is a chamber for evaporating water. In an alternate embodiment, water vapor production chamber 12 is a chamber for sublimating ice. In alternate embodiments, water vapor production chamber 12 may be any type of chamber for producing water vapor.

In one embodiment, water vapor production chamber 12 has a clear top and an open bottom. The open bottom rests in a body of water, such as salt water or other non-potable water source.

Water vapor conduit 16 is disposed between water vapor production chamber 12 and condensation chamber 14. As heated water vapor from combustion chamber 6 travels from combustion chamber 6 into condensation chamber 14, a Venturi effect is created, which generates a vacuum on water vapor conduit 16. The vacuum draws water vapor from water vapor production chamber 12 into condensation chamber 14.

In one embodiment, the vacuum generated on water vapor conduit 16 reduces the atmospheric pressure within water vapor production chamber 12. The reduced atmospheric pressure within water vapor production chamber 12 increases the rate of production of water vapor within water vapor production chamber 12.

Condensation chamber 14 allows water vapor to cool, which causes it to condense to purified liquid water. In one embodiment, condensation chamber 14 is cooled by air. In an alternative embodiment, condensation chamber 14 is cooled by water.

Condensation chamber 14 is disposed to receive water vapor from both combustion chamber 6 and water vapor production chamber 12. In one embodiment, condensation chamber 14 is disposed above combustion chamber 6 so that as the heated water vapor naturally rises, it flows into condensation chamber 14.

Water vapor in condensation chamber 14 is condensed into purified liquid water in condensation chamber 14. Receiving water vapor from both combustion chamber 6 and water vapor production chamber 12 produces more purified liquid water than receiving water vapor from only combustion chamber 6.

The condensed, purified, liquid water may be immediately distributed or collected in storage containers 50. Storage containers 50 are any container suitable for the storage of purified liquid water, such as barrels, jars, wells, cylinders, and the like.

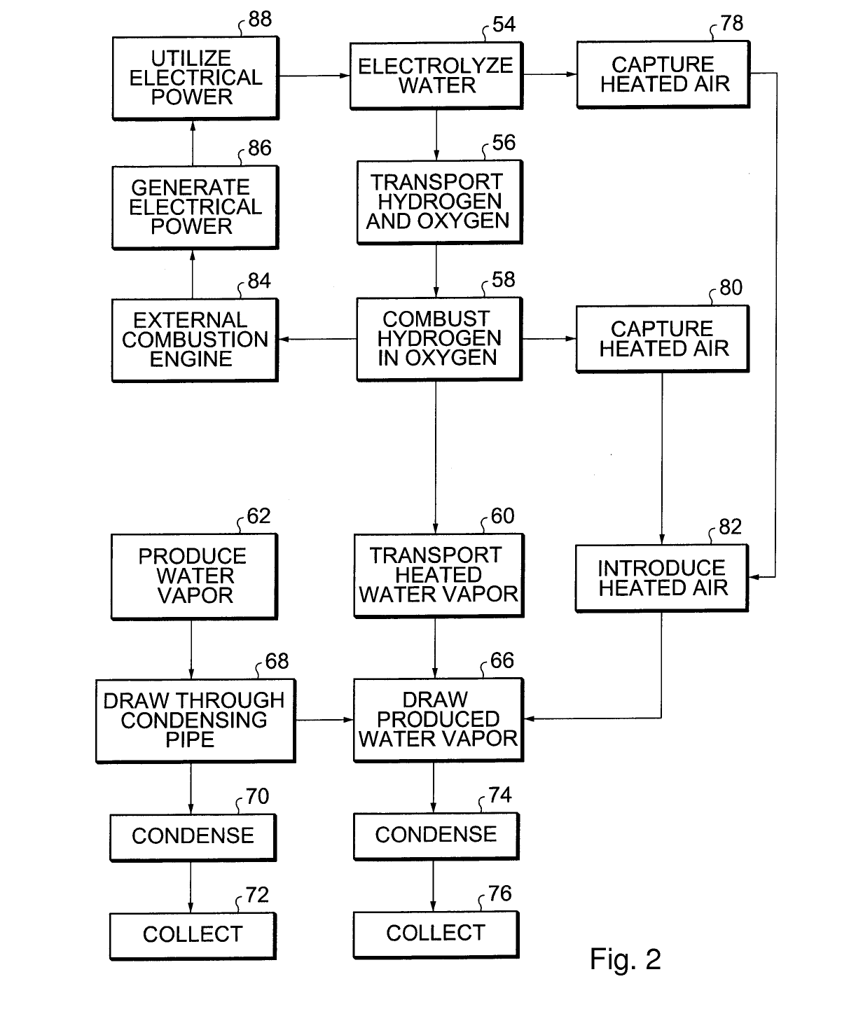

FIG. 2 is a flow chart representing steps of one embodiment method for purifying water. Although the steps represented in FIG. 2 are presented in a specific order, the technology presented herein can be performed in any variation of this order. Furthermore, additional steps may be executed between the steps illustrated in FIG. 2.

Water is electrolyzed 54 to generate hydrogen and oxygen. The hydrogen and oxygen are transported 56 to combustion chamber 6. The hydrogen is combusted 58 in the oxygen in combustion chamber 6 to generate heated water vapor.

The heated water vapor is transported 60 from combustion chamber 6 to condensation chamber 14. The heated water vapor moves across an opening to the water vapor conduit 16, in so doing, a vacuum is generated within water vapor conduit 16.

During this process, water vapor is produced 62 in water vapor production chamber 12 to form water vapor. In one embodiment, water vapor conduit 16 connects directly to water vapor production chamber 12.

The vacuum, generated by transporting 60 the heated water vapor from combustion chamber 6, draws 66 produced water vapor from water vapor production chamber 12.

The produced water vapor passing through water vapor conduit 16 joins the heated water vapor in condensation chamber 14 where they are both condensed 74 to purified liquid water and collected 76. Condensing 74 water vapor from both the combustion 58 and the water vapor production 62 produces more purified liquid water than receiving water vapor from only the combustion. Any remaining air is exhausted out of condensation chamber 14.

In order to improve the efficiency of the process, heated air may be captured 78, 80 from both the electrolysis process 54 and the combustion process 58. The captured heated air is introduced 82 into combustion chamber 6 to augment the vacuum generated by the heated water vapor traveling from combustion chamber 6 to condensation chamber 14. This captured heated air may also be introduced into or bubbled into water below water vapor production chamber 12 to augment evaporation of the water source.

An additional improvement to the efficiency of the process allows external combustion engine 30 to operate 84 from the combustion 58 of hydrogen in combustion chamber 6. Electrical power is generated 86 from the operation of external combustion engine 30. The electrical power may then be utilized as desired. In one embodiment, the electrical power is utilized in the electrolyzing 54 of water.

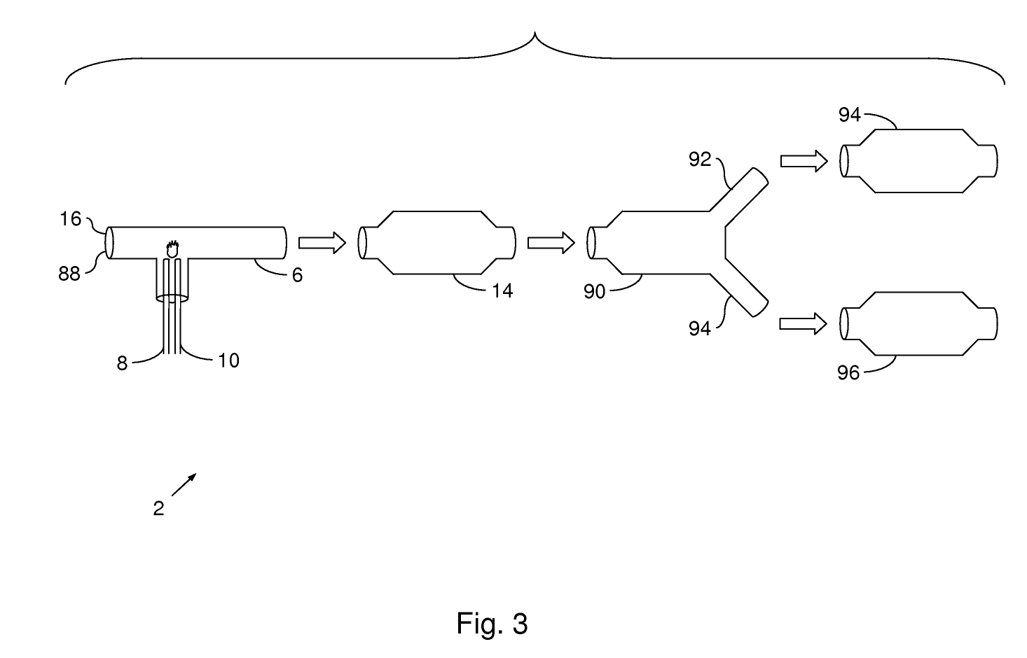

FIG. 3 illustrates an alternate embodiment of the present invention where ammonia liquor is produced during the water purification process. In this embodiment, water and ammonia are continuously produced by passing water vapor through a hydrogen-powered burn chamber 6 and separating potable water from nitrates and ammonia by evaporation. The primary element is the incineration of water vapor in hydrogen-powered flow-furnace chamber 6 to achieve and briefly sustain temperatures around 374 degrees C. 374 degrees C. is the temperature at which water reaches the supercritical state and destroys organic materials as well as fixates nitrogen in ambient air to hydrogen producing the substrate for purified water and nitrate fertilizer.

The ammonia production and water purification system includes burn chamber 6, oxygen supply 8, hydrogen supply 10, water vapor supply 16, ambient air supply 88, evaporation chamber 90, condensing passages 14, 92, ammonia liquor passage 94, purified water collection chamber 96, and ammonia liquor chamber 98.

Oxygen supply 8, hydrogen supply 10, water vapor supply 16, and ambient air supply 88 are disposed to deliver oxygen, hydrogen, water vapor, and ambient air, respectively, to burn chamber 6. Water vapor supply 16 delivers organic matter contaminated water vapor to burn chamber 6. Water vapor supply 16 and ambient air supply 88 may be integrated, as shown in FIG. 3, or discreet elements.

Condensing passage 14 is interconnected with burn chamber 6. Evaporation chamber 90 is disposed to receive condensation from condensing passage 14. Condensing passage 92 is interconnected with the evaporation chamber 90. Purified water collection chamber 96 is disposed to receive condensation from condensing passage 92. Ammonia liquor chamber 98 collects ammonia liquor from evaporation chamber 90. Ammonia liquor passage 94 interconnecting evaporation chamber 90 and ammonia liquor chamber 98.

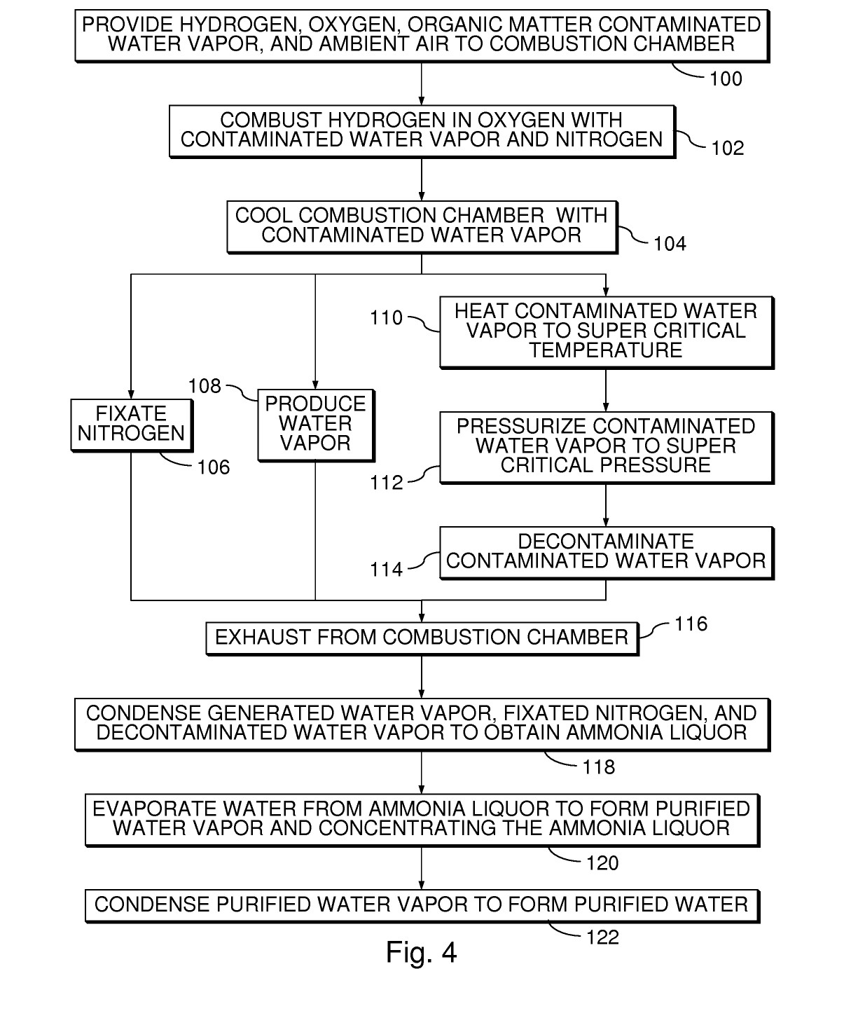

FIG. 4 is a flow chart representing steps of one embodiment method for producing purified water and ammonia. Although the steps represented in FIG. 4 are presented in a specific order, the technology presented herein can be performed in any variation of this order. Furthermore, additional steps may be executed between the steps illustrated in FIG. 4.

Hydrogen, oxygen, organic matter contaminated water vapor, and ambient air, containing nitrogen are provided to combustion chamber 6. In one embodiment, water vapor is obtained by evaporation in an enclosed chamber. In other embodiments, water vapor from any source is also acceptable.

In one embodiment, only the oxygen present in ambient air is provided to the combustion chamber. In an alternate embodiment, oxygen in addition to the oxygen present in ambient air is provided to the combustion chamber. For example, oxygen may be provided to the combustion chamber at a ratio of one oxygen molecule to two hydrogen molecules of hydrogen added to the combustion chamber. Oxygen may also be provided to the combustion chamber 6 at lesser or greater amounts, to control the temperature of combustion in the combustion chamber.

In another embodiment, hydrogen is burned in oxygen with only carbon dioxide introduced into the combustion chamber 6. The resulting heat of about 3200 degrees C. results in the direct conversion of carbon dioxide into pure carbon and oxygen. In this embodiment, pressures beyond atmospheric may be used to augment the process. The carbon produced may include graphite and diamonds or other forms of carbon structures.

In one embodiment, the pressure inside the combustion chamber is atmospheric pressure. In combustion chamber 6, the hydrogen is combusted 102 in the oxygen with the contaminated water vapor and nitrogen. In one embodiment, the contaminated water vapor cools 104 combustion chamber 6 and prevents combustion chamber 6 from overheating.

In one embodiment, the hydrogen is burned 102 in ambient air at a flow rate which results in combustion of all of the oxygen. This results in vapor containing only nitrogen, carbon dioxide, and rare gases. Water produced from burning 102 the hydrogen in the oxygen is removed by evaporation. The resulting oxygen free gas may be used for industrial and other applications.

Nitrogen is fixated 106 by burning hydrogen in ambient air. The water vapor is passed through hydrogen-powered flow-furnace 6, producing a vapor of purified water and also ammonia, nitrates, nitrites, and other nitrogenous substances. Water vapor is also produced 108 by the hydrogen burning in the oxygen.

In one embodiment, the contaminated water vapor is heated 110 to a super critical temperature of water. In one embodiment, the contaminated water vapor is pressurized 112 to a super critical pressure. The contaminated water vapor is heated to decontaminate 114 the contaminated water vapor.

The produced water vapor, fixated nitrogen, and decontaminated water vapor are exhausted 116 from combustion chamber 6. The produced water vapor, fixated nitrogen, and decontaminated water vapor are condensed 118 to obtain ammonia liquor. Water is evaporated 120 from the ammonia liquor to form purified water vapor and concentrate the ammonia liquor. The purified water vapor is condensed 122 to form purified water. In one embodiment, the entire process is accomplished without need for carbon-based energy.

In an alternate description, water vapor from any source [in one embodiment, from solar evaporation of salt or polluted water] is introduced into a flow-furnace burning hydrogen and oxygen [from any source but in one embodiment, from electrolysis of water powered by a non-carbon source. The water vapor, carried in ambient air rich in nitrogen, flows continuously through this chamber heated by the hydrogen flame. Exiting from this chamber is vapor which now contains ammonia, nitrates, nitrites, and other nitrogenous compounds through the process of nitrogen-fixation. This occurs at ambient air pressure as the vapor is maintained at a temperature of or greater than 374 degrees C. for a sufficient interval of time. This heat also incinerates any organic micropollutants found in the water to be processed. The vapor emerging from the hydrogen burn chamber is condensed [in one embodiment, in a pipe or chamber cooled by the supply of saline or unclean water]. This water, now pure except for the introduced nitrates is then re-evaporated. This vapor is then again condensed and this removes the nitrates leaving them in the remaining concentrate which is used as a fertilizer. The end products are extremely purified water and also useful nitrate fertilizer. The process can be powered in its entirety by non-carbon energy sources and adds desalination of water and fertilizer production to the usefulness of a solar and wind powered system of hydrogen in the storage and transmission of energy without carbon-based energy.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for purifying water and generating ammonia liquor, the method comprising:
providing hydrogen, oxygen, organic matter contaminated water vapor, and ambient air, containing nitrogen, to a combustion chamber;
in the combustion chamber, combusting the hydrogen in the oxygen with the contaminated water vapor and nitrogen to fixate the nitrogen, producing water vapor, and heating the contaminated water vapor to decontaminate the contaminated water vapor;
the produced water vapor, fixated nitrogen, and decontaminated water vapor exhausting from the combustion chamber;
condensing the produced water vapor, fixated nitrogen, and decontaminated water vapor to obtain ammonia liquor; and
evaporating water from the ammonia liquor to form purified water vapor and concentrating the ammonia liquor.

2. The method of claim 1 further including condensing the purified water vapor to form purified water.

3. The method of claim 1 further including the contaminated water vapor cooling the combustion chamber.

4. The method of claim 1 wherein the pressure inside the combustion chamber is atmospheric pressure.

5. The method of claim 1 wherein heating the contaminated water vapor to purify the contaminated water vapor includes heating the contaminated water vapor to a super critical temperature of water.

6. The method of claim 5 further including pressurizing the contaminated water vapor to a super critical pressure to purify the contaminated water vapor.

7. The method of claim 1 wherein providing oxygen to the combustion chamber includes only providing the oxygen present in ambient air to the combustion chamber.

8. The method of claim 1 wherein providing oxygen to the combustion chamber includes providing oxygen in addition to the oxygen present in ambient air to the combustion chamber.

9. An ammonia production and water purification system, the system comprising:
a burn chamber;
a hydrogen supply disposed to deliver hydrogen to the burn chamber;
an oxygen supply disposed to deliver oxygen to the burn chamber;
a water vapor supply disposed to deliver organic matter contaminated water vapor to the burn chamber;
an ambient air supply disposed to deliver ambient air to the burn chamber;
a first condensing passage interconnected with the burn chamber;
an evaporation chamber disposed to receive condensation from the condensing passage;
a second condensing passage interconnected with the evaporation chamber;
a purified water collection chamber disposed to receive condensation from the second condensing passage;
an ammonia liquor chamber for collecting ammonia liquor from the evaporation chamber; and
an ammonia liquor passage interconnecting the evaporation chamber and the ammonia liquor chamber.

10. The ammonia production and water purification system of claim 9 wherein the organic matter contaminated water vapor supply and ambient air supply to the burn chamber are integrated.
